(19) United States
(12) Patent Application Publication
(10) Pub. No.: US 2009/0146843 A1
(43) Pub. Date: Jun. 11, 2009

(54) Residential garage parking position indicator

(76) Inventor: Donald James Dobson, San Diego, CA (US)

Correspondence Address: Donald Dobson, 3767 Ruette San Raphael, San Diego, CA, 92130, US

(21) Appl. No.: 12/315,198

(22) Filed: Dec. 1, 2008

Related U.S. Application Data
(60) Provisional application No. 61/005,522, filed on Dec. 6, 2007.

(51) Int. Cl. B60Q 1/48; G05B 19/00

(52) U.S. Cl. 340/932.2; 340/5.71

(57) ABSTRACT

A residential garage can be either attached or detached from a residence and normally includes a paneled, roll-up door that can be opened and closed either manually or via mechanical means utilizing a motor and drive system. A pendant (soft target) suspended from a cord is movable in a vertical direction from a raised position (garage door closed) to a lowered position (garage door open) via direct linkage and travel reduction of the cord to the top of the garage door, suspended from the garage ceiling with guides. When the garage door is raised and the pendant is lowered, a driver in a vehicle can park in the garage utilizing the pendant to properly and precisely align the vehicle inside the garage by stopping the vehicle at the point when the vehicle windshield first contacts the pendant.

### REFERENCES CITED

U.S. Patent Documents

| | | |
|---|---|---|
| 3,817,203 | June 1974 | Brauer |
| 3,872,820 | March 1975 | Hess |
| 3,874,322 | April 1975 | Brauer |
| 4,490,917 | January 1985 | Pilling |
| 5,297,500 | March 1994 | Wilson |
| 5,315,953 | May 1994 | Mullarkey, Jr. |
| 5,832,865 | November 1998 | Harmel |
| 6,209,478 | February 1999 | Curtis |

### BACKGROUND OF THE INVENTION

1. Field of the Invention

The invention relates to a residential garage incorporating a vehicle parking alignment device that moves in a vertical fashion in conjunction with the opening or closing of a garage door.

2. Description of Prior Art

The action of parking a vehicle inside a garage can be challenging, particularly if the garage is smaller than usual; the garage is also used for storage and available parking area is minimal; the vehicle to be parked is larger than normal; or the driver of the vehicle is relatively inexperienced (teenage driver).

The idea of utilizing some sort of positioning indicator inside a residential garage has been with us for many years, and many different solutions to assist in parking a vehicle in a garage have been developed. All have their relative benefits and detriments. Most are expensive to construct (complex designs), and some are relatively simple.

One type of indicator consists of an object that is suspended from a flexible element (cord) and attached to the garage ceiling in a fixed or non-retractable position. When the windshield of a vehicle touches the object, the vehicle is properly positioned in the garage.

One significant problem with this design is that the object suspended from the garage ceiling can hinder freedom of movement inside the garage when the vehicle is not present.

To overcome this drawback, the object is suspended in such a manner that it rises to the ceiling as the garage door is closed, and lowers to windshield height when the garage door is opened. This is currently achieved by attaching the flexible element (cord) and pendant to the garage door.

This design however presents another problem. In some garages, the optimal distance from the driver's line of sight in the vehicle to the garage ceiling is less than the linear distance through which the garage door moves (e.g. 80 inches of garage door linear movement versus 50 inches of optimal travel between a driver's line of sight and the garage ceiling). Therefore, it becomes necessary to compensate in some manner for the difference in travel between the garage door and the position alignment device movement.

As disclosed in U.S. Pat. No. 6,209,478, one way to compensate for the difference in the distances of travel is to utilize a retraction device with an adjustable diameter coiling mechanism powered in various ways by the garage door mechanical systems. This design is relatively expensive to manufacture and time-consuming to install due to its inherent complexity.

Another solution to compensate for the object and garage door travel distances was offered in U.S. Pat. No. 5,832,865 by making a part, or the entire flexible element (cord) elastic. One key disadvantage of this design would be that like all elongated, elastic devices, the code would lose its elasticity over time and will eventually break. This makes the approach unreliable, and possibly a safety hazard in that the resulting falling object could strike a person on the head or in the face.

Yet another approach as specified in U.S. Pat. Nos. 3,874,322 and 3,817,203 to compensate for the difference in the travel distances of the object and garage door describes the use of a reel having two portions of different diameter. Two cords are used with one of the cords attached to the garage door and to the larger diameter portion of the reel. One end of the second cord is attached to the object while the other end is attached to the smaller diameter portion of the reel. When the garage door closes, the travel that occurs by the cord attached to the garage door is used to pull on the larger diameter reel causing rotation of the reel. In turn, the other cord attached to the object is pulled onto and wound around the reel and causes the object to move up toward the garage ceiling. Likewise, when the garage door is opened, the cord attached to the garage door is no longer under tension, and the weight of the object allows the reel to reverse direction and the object to drop.

This arrangement is also expensive to manufacture, and difficult to install and is cost prohibitive due to its inherent complexity.

### SUMMARY OF THE INVENTION

It is an object of the invention to provide a garage vehicle parking alignment device that allows complexity inherent in previous designs to be substantially reduced.

Another object of this invention is to provide a garage vehicle parking alignment device that is inexpensive to manufacture.

A further object of this invention is to provide a garage vehicle parking alignment device that is relatively easy to install, and at the same time possess the ability to quickly and easily compensate for the varying residential garage floor to ceiling heights.

A further object of this invention is to provide a garage vehicle parking alignment device that presents a pendant that incorporates rotational stability such that the pendant remains in a fixed rotational orientation throughout its linear, vertical travel.

Another object of this invention is to provide a garage vehicle parking alignment device that provides a means to easily adjust the longitudinal position of the pendant relative to the vehicle being parked so as to compensate for variable distances from the front of the vehicle (grill) to the windshield of various makes and model of vehicle.

An additional object of this invention is to provide a garage vehicle parking alignment device that is reliable.

Another object of this invention is to provide a garage vehicle parking alignment device that poses no safety hazard to people in the vicinity of the device.

The preceding objects, as well as others that will become apparent as the description progresses—are achieved by the invention.

One aspect of the invention is located in a garage incorporating a garage door that is movable between a closed and open position. The garage further includes the means for indicating a vehicle parking position after the garage door travels to an open position. The indicating means includes an elongated flexible element attached at one end to a pendant and at the other end to the top of the garage door, or to the garage door linear movement means.

Another aspect of the invention resides in a method of operating a garage door. The method includes the steps of moving the garage door from a closed position to an open position utilizing moving means, and providing an indication of vehicle position in response to the moving step. The method further includes the steps of returning the garage door to the closed position by way of the moving means, and subsequent return of the vehicle positioning pendant toward the garage ceiling facilitating full, unobstructed use of the garage.

Another aspect of the invention resides in a method of suspending a low mass pendant from the garage ceiling utilizing lightweight, stationary or pivotal hooks (threaded or adhesive backed tape) to facilitate ease of installation and adjustment in conjunction with a readily available, lightweight, high strength, low friction, small diameter flexible element.

Another aspect of the invention resides in the method of routing and attaching the cord to the pendant so as to provide a fixed rotational position of the pendant relative to the vehicle driver.

Another aspect of the invention resides in the method of routing and attaching the pendant cord to the ceiling guides and through the pendant so as to achieve a pendant linear, vertical travel distance reduction ratio that is approximately one-half that of the horizontal movement of the garage door (garage door moves 2 inches, pendant moves 1 inch).

Additional features and advantages of the invention will be forthcoming from the following detailed description of preferred embodiments when read in turn with the accompanying drawings.

### BRIEF DESCRIPTION OF THE DRAWINGS

FIGS. 1a and 1b are schematic sectional side views of a garage illustrating the principle of operation of the vehicle parking alignment device according to the invention.

FIGS. 2a, 2b and 2c are plan views of examples of various styles of guides (non-exclusive) for the flexible element that constitutes part of the vehicle parking alignment device as shown in FIGS. 1a and 1b.

FIG. 3 is a schematic sectional view of a garage illustrating one embodiment of a vehicle parking alignment device in accordance with the invention.

FIG. 4 is a plan view of the guide attachments for the flexible element and flexible element routing through the guides and pendant that constitute part of the vehicle parking alignment device as shown in FIGS. 1a and 1b.

FIGS. 5a, 5b and 5c are plan and isometric views of various non-exclusive styles of pendants 16 that could be used to provide the desired functional and aesthetic characteristics for this part of the invention.

### DESCRIPTION OF THE PREFERRED EMBODIMENTS

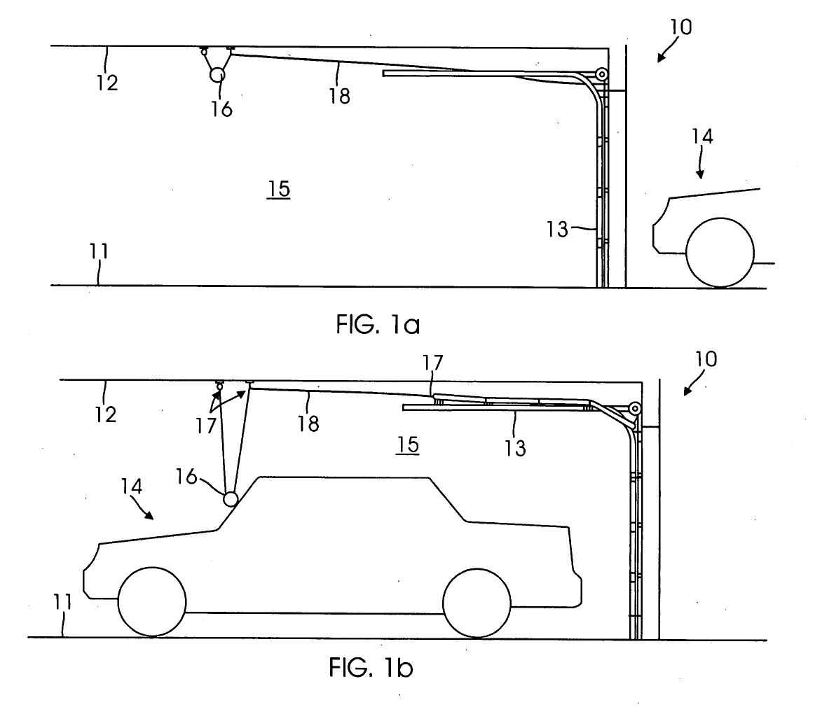

FIG. 1a schematically illustrates the principle of operation of a vehicle parking alignment arrangement in accordance with the invention. In FIG. 1a, the numeral 10 identifies a residential garage. The garage 10, which has a floor 11 and a ceiling 12, defines a space 15 serving as a parking area for a motor vehicle 14 and as an auxiliary storage area. The motor vehicle 14 enters and leaves the garage 10 through an entrance and exit opening which can be opened and closed by a conventional garage door 13. The garage door 13 is movable between a lowered or closed position and a raised or open position by a non-illustrated automatic garage door opener or moving means. In FIG. 1a the garage door 20 is in a normal closed position. In FIG. 1b the garage door 13 is in a normal open position, which allows ingress and egress of the motor vehicle 14.

A pendant which constitutes a vehicle parking alignment indicator is shown here as a typical pliable, round object 16 such as a ball. The pendant is suspended by a cord or flexible element 18, one end of which is attached to the ceiling 12 by a guide 17 and subsequently passes through the pendant 16 and returns to and passes over a second ceiling guide 17 and then on to the garage door 13 and attached at the top of the garage door 13. When the garage door 13 is closed as in FIG. 1a, the pendant 16 is raised to a position toward the garage ceiling 12. When the garage door 13 is fully closed, the pendant 16 stops at a resting position at an approximate height of 80 to 100 inches above the garage floor 11.

During normal operation, the garage door 13 is opened when a motor vehicle 14 is to be parked in the garage 10. As the garage door 13 is opened, the pendant 16 falls to a lowered position shown in FIG. 1b. When the garage door 13 is fully opened, the pendant 16 will stop and come to rest at its lowest position at an approximate height somewhere near the driver's line of sight at the height of the motor vehicle 14 windshield.

The motor vehicle 14 subsequently enters the garage 10 and moves forward until the windshield touches the pendant 16. This is illustrated in FIG. 1b and shows that at this point, the motor vehicle 14 is properly aligned in the garage 10 and is stopped. The garage door 13 is subsequently activated to close and, as the garage door 13 closes, the pendant 16 returns to its fully raised position.

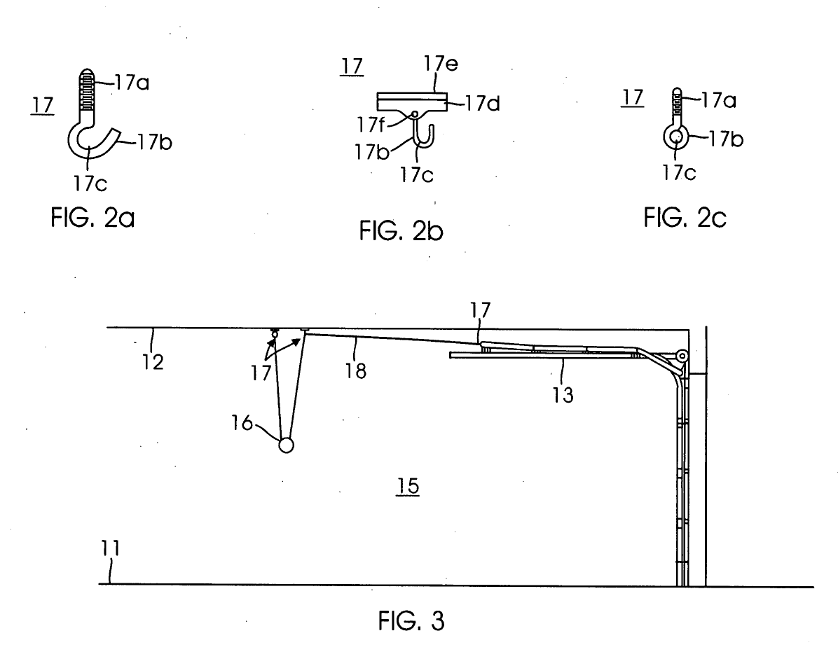

In FIGS. 2a, 2b and 2c, several variations of cord guide 17 are depicted. FIG. 2a shows a typical utility hook guide 17 that is comprised of a threaded shank 17a and hook shaped appendage 17b and opening 17c. FIG. 2b shows another style of utility hook that can be fixed to object utilizing an adhesive backed tape 17e permanently attached to the body of the hook 17d. The hook body 17d can be either plastic metal, and in some cases pivotal 17f rather than fixed. FIG. 2c shows yet another style of guide 17, this time a screw eye design with a treaded shank 17a and a circular head 17b that defines an opening 17c for the cord 18 to pass through.

Virtually any type of guide 17 can be used so long as it provides a passage over which or through the cord 18 may pass and a means to permanently affix to the garage ceiling 12 and the top of the garage door 13.

In FIG. 3, it is illustrated that the cord 18 is attached at one end to a guide 17 which is fixed to the garage ceiling 12, and is subsequently routed down to the pendant 16 at which point it passes through a cylindrically shaped passageway 19 through the pendant 16 (entry and exit holes through the pendant 16 one or more inches apart) and back up to another guide 17 fixed to the garage ceiling 12. The cord 18 then passes over the hook shaped guide 17 and travels along the garage ceiling down to the top of the garage door 13 where the other end of the cord 18 is attached to yet one more guide 17 fixed to the top of the garage door 13.

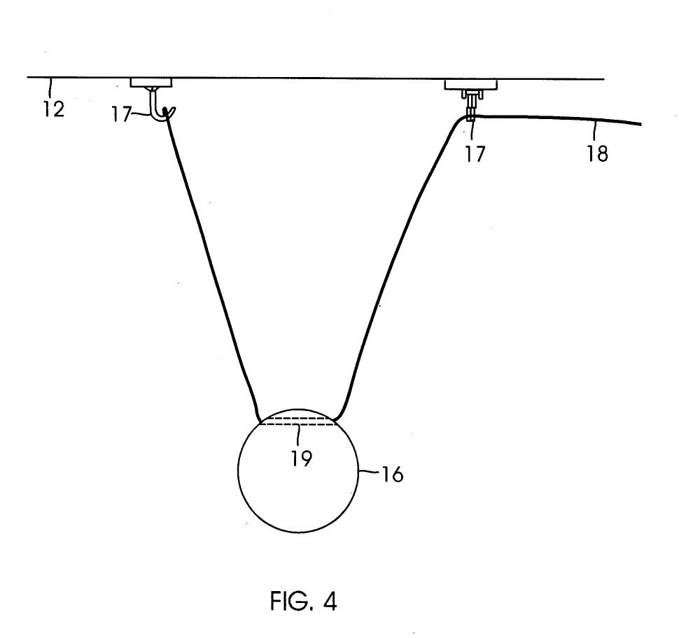

FIG. 4 depicts the routing of the cord 18 from a guide 17 attached to the garage ceiling 12, then down to the pendant 16, then passing through the pendant 16 via a hollow channel and tubular insert 19, and back up to another guide 17 attached to the garage ceiling 12 and on to a final attachment guide 17 positioned on the top of the garage door 13 (not shown in FIG. 4, refer to FIG. 1b).

Alternately, the two cord guides 17 attached to the garage ceiling 12 could be movable and attached to a track mounted to the garage ceiling 12 allowing for easy adjustment of the guides 17 to compensate for the positioning of various makes and models of motor vehicle.

Additionally, and again referring to FIG. 4, the pendant 16 style can be variable in that different shapes and materials of construction could be used so long as the weight of the pendant 16 remains relatively, lightweight and within a range of one to eight ounces. Various other means could be used to achieve the desired two attachment points on the pendant 16 so as to maintain a rotational fixed position. For instance, if the pendant 16 were to be manufactured from a moldable plastic, the two attachment points could be an integral part or component of the pendant 16. Another possible method for achieving a minimum of two attachment points on the pendant 16 could be to add mechanical hardware after fabrication of the pendant 16, such as screw eye hooks. The distance between the two or more attachment points on the pendant 16 can be variable, but sufficient to provide the desired rotational stability of the pendant (fixed rotational position).

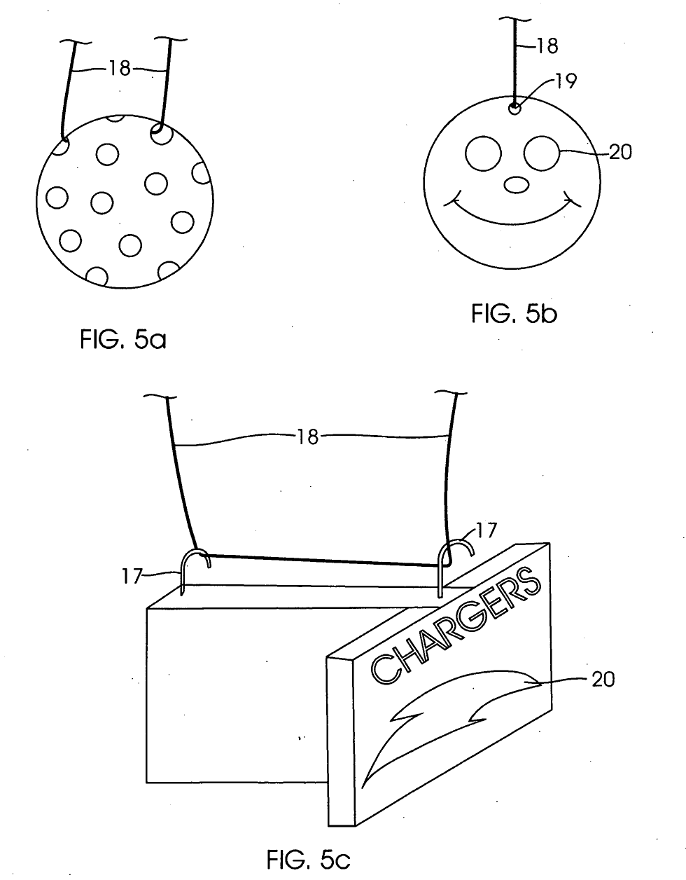

FIGS. 5a, 5b and 5c depict several variations of a pendant 16 that can be employed to serve as a visual aid to the driver to determine when the motor vehicle 14 is properly aligned in the optimal parking position. FIG. 5a shows a plastic wiffle ball that contains many small diameter holes in the hollow structure allowing an entry and exit pathway for the cord 18 to pass through. FIG. 5b shows another type of spherically shaped pendant 16 suitable for silk-screening a graphic 20. The pendant 16 can be manufactured from metal, plastic, wood, solid, hollow, rigid, pliable or compressible material—so long as it is reasonably lightweight and provides a suitable surface for silk-screening or embossing a desired graphic 20. FIG. 5c shows yet another style of pendant 16 that is “tee” shaped and includes a means for the cord 18 to pass through the top. The construction can be virtually any material and any geometric shape, so long as it remains reasonably lightweight and presents a surface that can accept a graphic 20 by application of a decal, silk-screening, embossing or other means.

The pendant 16 suspended from the cord 18 may have any shape and may be made of any of a variety of natural or man-made materials. Preferably, the outside layer of the pendant 16 is soft so as to prevent any inadvertent damage to a motor vehicle 14 or injury to people. It may also be desirable for the outside layer of the pendant 16 to be suitable for acceptance of a graphic 20 that can be applied by a decal, painting, printing, or embossing. This will allow the pendant to be colored and/or to be provided with text, logos, graphic designs to provide a means for business advertising, or to make the pendant 16 more aesthetically pleasing to the consumer.

The pendant 16 can be designed to glow in the dark or may incorporate a means to provide one or more steady or flashing lights of the same of different colors, activated either remotely, or through a motion or impact detection means, among others.

The pendant 16 could include a sound generation capability activated in a similar manner as described above for lights.

The cord 18 can be made from a variety of flexible natural or synthetic materials including metal and plastic, such as 10 to 20 pound test nylon fishing line. The cord 18 could be single or multiple-strand, smooth or textured construction. The cord 18 could also employ a means to glow in the dark.

I claim:

1. A garage comprising:
a garage door movable between a closed position and an open position;
means for moving said garage door between said closed position and said open position; and
means for indicating a parking position when said garage door is in said open position, said indicating means including an elongated flexible element, and suspension travel reduction member in response to movement of said garage door, said member including multiple suspension fixtures which constitutes part of said member, and said multiple suspension fixtures attached to garage ceiling and said garage door.

2. A garage comprising:
a garage door movable between a closed position and an open position;
means for moving said garage door between said closed position and said open position; and
means for indicating a parking position when said garage door is in said open position, said indicating means including an elongated flexible member, and an indicator for said parking position, said indicator being a suspension travel reduction member in response to movement of said garage door, said member including multiple suspension guides which constitutes part of said member, and said multiple suspension guides attached to garage ceiling and said garage door, said member being suspended from said flexible element.

3. A garage comprising:
a garage door movable between a closed position and an open position;
means for moving said garage door between said closed position and said open position; and
means for indicating a parking position when said garage door is in said open position, said indicating means including an elongated flexible member, and an indicator for said parking position, said indicator being a suspension travel reduction member in response to movement of said garage door, said member including multiple suspension guides which constitutes part of said member, and said multiple suspension guides attached to garage ceiling and said garage door, said member accomplishing an approximate two to one reduction in travel of said indicator compared to the travel of said garage door.

4. A method of operating a garage door comprising the steps of:
moving said garage door from a closed position to open position, the moving step being performed employing moving means;
providing an indication of a parking position in response to the moving step;
returning said garage door to said closed position, the returning step being performed employing said moving means; and
removing said indication, the providing step and removing step being performed using means for indicating said parking position, and said indicating means including an elongated flexible element, and a suspension travel reduction member in response to movement of said garage door, said member including multiple suspension guides which constitutes part of said member, and said multiple suspension guides attached to garage ceiling and said garage door, said member accomplishing a two to one reduction in travel of said indicator compared to the travel of said garage door, said member being suspended from said flexible element, and the providing step including lowering said member and the removing step including raising said member.
